(19) United States
(12) Patent Application Publication
(10) Pub. No.: US 2004/0210873 A1
(43) Pub. Date: Oct. 21, 2004

(54) Automatic devlopment of software codes

(76) Inventor: Nicholas James Tudor, Bristol (GB)

Correspondence Address: JOHN S. PRATT, ESQ, KILPATRICK STOCKTON, LLP, 1100 PEACHTREE STREET, ATLANTA, GA, 30309, US

(21) Appl. No.: 10/480,023

(22) PCT Filed: Jun. 6, 2002
(86) PCT No.: PCT/GB02/02559

(30) Foreign Application Priority Data
Jun. 8, 2001 (GB) 0113946.8

(51) Int. Cl. G06F 9/44

(52) U.S. Cl. 717/124; 717/104

(57) ABSTRACT

Development of verified software codes is a very laborious process and is important especially where safety critical applications are concerned. A method is provided for the generation of verified software code against a requirement, which method comprises the steps of: i. using software to generate a static model of the requirement, ii. using the state model to develop a software code representation of the state model and a mathematical representation of the state model. iii. comparing the software code and mathematical representations to verify that the software code representation is a correct implementation of the mathematical representation.

The present invention relates to a methodology and its implementation in the development of software based codes, which may, for example, be used for the control of systems such as avionics.

Software based implementation of control functions in hardware has become increasingly complex over the years, with increased reliance on software to provide ever more complex control operations. This has resulted in the development of very large amounts of software code to provide for the complex control operations.

One such example, is the development of software code for implementation within the avionics systems of modern fighter aircraft, such as the Eurofighter. The performance characteristics of such aircraft are enabled by their operating in an aerodynamically unstable state. This requires the assistance of large amounts of extremely complex computer software. Development and certification of such software can be a very time consuming process. In the case of Eurofighter, the flight control system has been under development for over 12 years. It is known that no software, including that for safety critical systems, can be categorically confirmed as being free of errors or bugs. This is evidenced by the numerous spectacular failures of land, sea and air based real and non-real time systems that have occurred in the past. Consequently, there is needed an extensive certification process to determine that the software operates in the expected manner under all circumstances. Such certification will be required when the software is initially developed and at any time when subsequent modifications are made to the software or the system within which it operates. This will aid ensuring that the manner of operation of the software is certified as correct.

The requirements for software are derived from a system specification. Once the software requirements have been finalised, a specification can be written as a mathematical representation of the software requirements. Software code is then developed to reflect accurately the specification. For safety critical software in particular, this is a painstaking process normally undertaken manually. This is a very inefficient method of developing any software.

Around 20 years ago a mathematical approach to software development, known as Formal Methods (FM), was emerging as a potential method for gaining assurance that the software code would accurately reflect the specification. FM employs a formal specification which is written in a mathematical representation. From the formal specification it is possible, through a variety of mathematical techniques, to produce software code which effects the formal specification exactly. This mathematical technique can be subjected to proof—a technique called verification. However, FM has not been developed into a widely usable format and has largely remained in the realm of academics because FM are very difficult to understand. FM employs a conceptually difficult branch of mathematics, which probably gave rise to a reluctance to use and hence gain wider acceptance. In particular, providing proof is very laborious, time consuming and an extremely skilled process. Furthermore, FM can be unwieldy even for small applications and is hampered by a lack of practitioners, which thereby makes it expensive to undertake.

A consequence of the above has been a distinct reluctance for manufacturers to implement safety critical processes by way of software. However, in the last few years work has progressed in the field of automated software development. In particular, the Defence Evaluation & Research Agency (DERA) at Malvern, Worcs, England has been developing tools for the automatic derivation of formally verified flight control law code. This approach is being used to verify the flight control system code for Eurofighter. It operates by generating a Simulink® model using existing commercial software packages. Simulink® forms part of a commercial software package known as MATLAB® which is a product of The MathWorks Inc. The Simulink® model is a mathematical representation of the software requirements. Simulink® automatically generates SPARK Ada code, SPARK Ada being a computer programming language. The Simulink® model is also used by a tool called ClawZ to automatically generate a formal specification in a mathematical language called ‘Z’. ClawZ is a tool developed by DERA that translates the expression of control law models between the Simulink® model and ‘Z’. The formal specification in ‘Z’ and the SPARK Ada are then compared to one another, with the SPARK Ada being altered as required to construct a compliance argument using the compliance notation tool within ProofPower®; this is done automatically. ProofPower® is a product of Lemma 1 Ltd. The compliance notation tool then generates the altered SPARK Ada as compilable files and verification conditions (VCs). By using the theorem prover part of ProofPower®, it is possible to perform software-tool assisted mathematical proof that the VCs are mathematically ‘true’. This thereby confirms or otherwise, that the altered SPARK Ada code is a correct representation of the formal specification and hence the Simulink® model. Much of the proof effort is automated.

Independently of the above there has been some work on the development of commercial software packages by the use of state-based modelling, with state models being developed from the software requirements.

The concept of a state model is best explained by way of example; the example chosen herein is that of a thrust reverser on a jet engine of an aircraft. A state model of the thrust reverser would model each ‘state’ that the thrust reverser can occupy [e.g. State 1: Disengaged; State 2: Partly engaged; State 3: Fully engaged], with a corresponding list of ‘rules’ that govern allowable actions within and transition between each state. The same principle can also be applied to the development and operation of software code.

Accordingly there is provided a method for the generation of verified software code against a requirement, which method comprises the steps of:

i. using software to generate a state model of the requirement,

ii. using the state model to develop a software code representation of the state model and a mathematical representation of the state model,

iii. comparing the software code and mathematical representations to verity that the software code representation is a correct implementation of the mathematical representation.

When developing systems comprising multiple, simultaneously active components that interact with one another, errors such as live-lock and dead-lock can occur. Such errors can lead to poor performance, unpredictable behaviour and system failure. To avoid such problems, a technique known as Model Checking can be employed, Model Checking being a technique for formally verifying finite-state concurrent systems. Accordingly, the above method can comprise an additional step of performing Model Checking to demonstrate absence of state-related errors such as dead-lock and live-lock.

The method will enable the automated development of software code by the use of state-based modelling. Although this will be especially useful in the field of safety critical software, there is no reason why it could not be applied to the development of any software. It will result in considerable development cost savings for software, through allowing development to be achieved in much shortened time scales compared to the use of existing methods (such as FM). It will also be of particular benefit in reducing the through-life costs of equipment, as any changes can be made at the requirement level and the majority of the remaining effort is automated. In particular, the method will be useful in the field of avionics systems. Accordingly, the method may be employed such that the verified software code produced is software control code.

The state model can be developed using an appropriate commercial software package such as Stateflow®. Stateflow® is a product of The MathWorks Inc. The software code representation of the state model can be developed using an auto-generated safe subset of language which can accommodate the requirements of concurrent programming such as the Ravenscar profile for Ada (currently referred to as ‘RavenSPARK’), or some other similar approach. The mathematical representation of the state model can be developed using an auto-generated formal language such as ‘Circus’ or some other comparable formal language. ‘Circus’ is a language which essentially combines two other formal languages, namely Communicating Sequential Processes (CSP) and ‘Z’. Model Checking can be performed using a tool such as FDR (Failures-Divergence Refinement).

According to a further embodiment of the present invention, there is provided a method for the generation of verified software code, which method comprises the steps of:

i. developing a statement of requirements,

ii. using software to generate a state model from the statement of requirements,

iii. developing from the state model a formal specification in a mathematical representation,

iv. using the state model to develop software code which represents the state model,

v. constructing a compliance argument using the mathematical representation and the developed software code to provide verification conditions,

vi. generating new software code where there is disparity between the mathematical representation and the developed software code,

vii. discharging the verification conditions to prove that the new software code is a correct representation of the mathematical representation and hence the statement of requirements.

The above method can comprise an additional step of performing model checking on the formal specification.

The present invention is seen as being of particular benefit in the field of avionics systems, in particular through implementation in Advanced Avionics Architectures (AAA). The principle of AAA is the removal of common functions from discrete systems, which are then implemented on ‘pooled’ resources. This enables diverse systems such as Fight Control, Armament Control and Sensoring (such as radar) to share common resources. An AAA system has inherent redundancy, which enables the system to reconfigure itself to cope with the failure of multiple hardware components whilst retaining functionality. However, the features of AAA which provide such inherent redundancy make certification of the underlying software very difficult. The main driver for AAA Is the lack of military hardware components. Therefore, commercial-off-the-shelf (COTS) components have to be used. The cost benefits of using COTS based re-configurable avionics systems are that they are easy to upgrade with the consequent long-term benefits. However, the software which gives such a system its functionality has to be platform (micro-processor) independent and as far as possible the software design has to be automated and readily certifiable. It also adopts an open system approach and therefore may be applied very widely. The present invention has the objective of generating software code that is certifiable against the specification in each instance. Other approaches have a high risk of being uncertifiable, with the incurred costs of development etc having been wasted. The present invention enables a system designer to make numerous iterations to a design, with only small costs being involved in achieving a certified system for each iteration. This is particularly useful for in-service safety critical software, which in the past has been extremely costly to modify. Using the present invention, any modification is relatively straightforward as it is automated and the result Is certifiable. This also has major implications for upgrades, which may need to be achieved in operationally significant timescales. This is especially true in the field of upgrades to military equipment, e.g. fighter aircraft avionics, during a time of conflict. However, the present invention may also be beneficial in other areas such as the automotive industry where product recall Is extremely expensive.

The present invention will now be described by way of example only and with reference to the accompanying drawings of which:

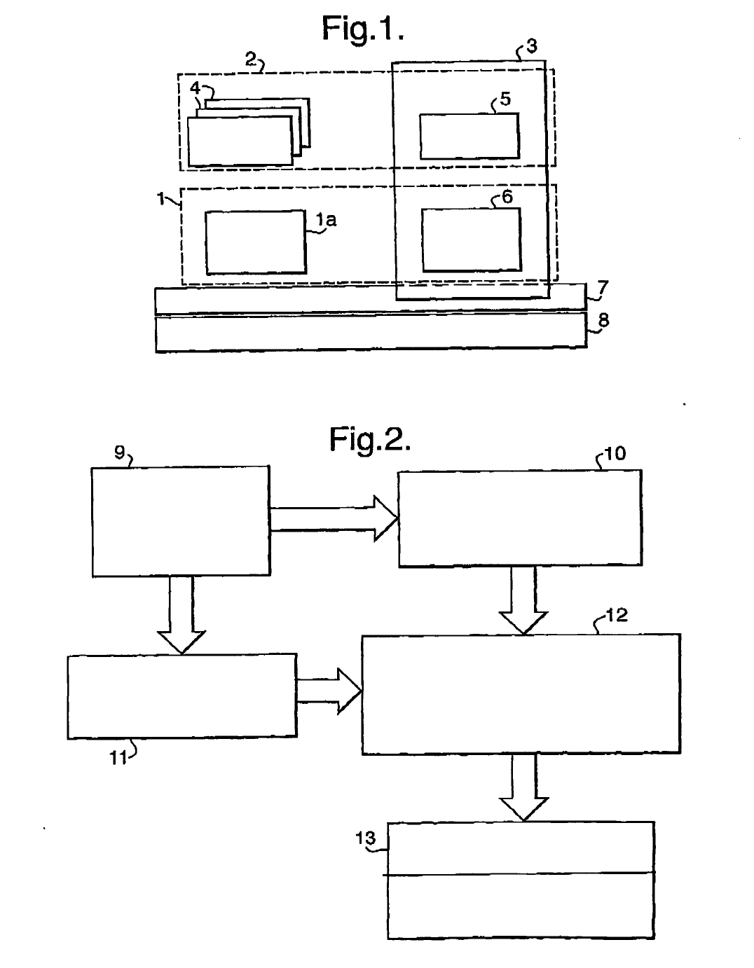

FIG. 1 shows a schematic example of Advanced Avionics Architecture (AAA) implemented in software,

FIG. 2 shows schematically a known methodology used in the development of certified software control codes, namely a conventional ClawZ based approach,

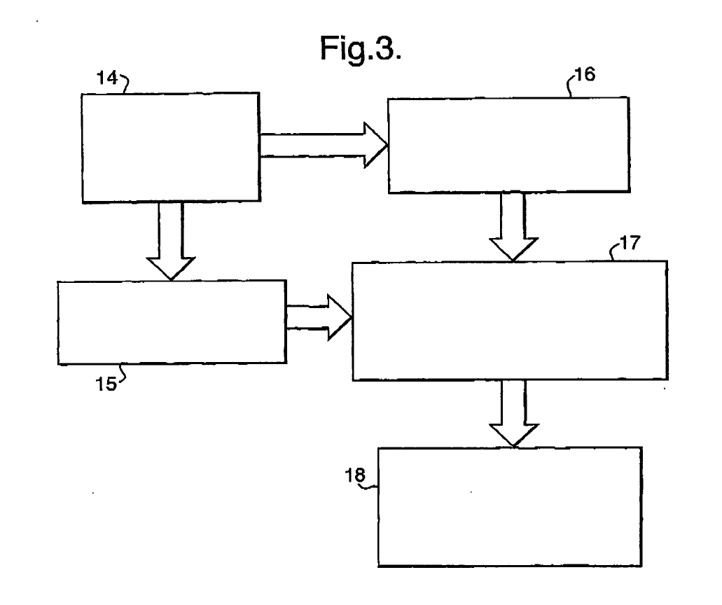

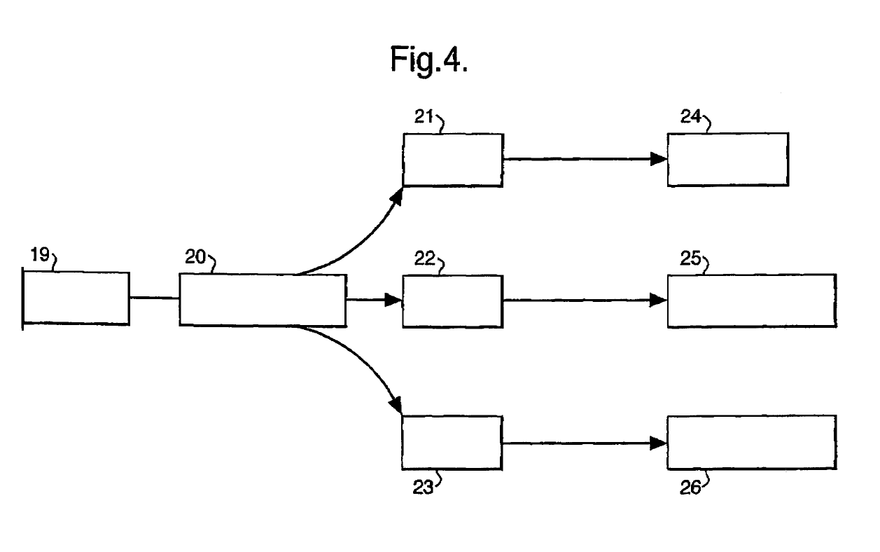

FIG. 3 shows schematically the method of the present invention used in the development of certified software control codes, namely the use of state-based modelling, and

FIG. 4 shows schematically an overview of the application of the present invention as it may be applied to AAA.

The software within AAA as shown in FIG. 1 can be thought of as three discrete sections. They comprise a real time operating system layer (1) as shown by the dotted line, application layer software (2) as shown by the dotted line and AAA control software (3). The operating system layer (1) comprises an operating system (1a). The application layer software (2) comprises a number of functional applications (4). The operating system layer (1) and the application layer software (2) are linked together through the AAA control software (3), the AA control software (3) comprising application management code (5) associated with the application layer software (2) and generic system management software (6) associated with the operating system layer (1). All three sections are supported by a board support layer (7) and a processor (8).

In order to certify AAA software each of the three sections has to be certified. The key to AAA is platform independence. Accordingly, it is important that the three sections are insulated from the processor (8) as far as possible. The AAA control software (3) allocates resource priorities as required and reassigns functionality to processors on hardware failure. It is broadly an ‘if then else’ function and prioritises according to precoded algorithms. This leads to difficulties with the certification of the application layer software (2), as the functions cannot be segregated without undermining the principal advantages of AAA. This makes certification of AAA control code software and application software inherently difficult to achieve.

As shown in FIG. 2 of a known methodology, using specialist software makes it possible to generate a Simulink® model (9) of the developed application layer software (2). This model may then be used to automatically generate a software code representation in SPARK Ada (10) and a mathematical representation in ClawZ ‘Z’ file form (11) of the Simulink® model (9). The software code representation (10) is then compared With the ClawZ ‘Z’ file (11) to construct compliance arguments in ProofPower® and to generate verification conditions as shown by (12). If it is verified that the ClawZ ‘Z’ file (11) and the software code representation (10) comply, then the verification conditions are discharged (13) providing the required certification.

FIG. 3 of the method of the present invention shows that by inputting the requirements of a control system to a suitable software package, for example Stateflow®, a state model (14) may then be directly developed. This state model (14) is then used to provide an input for the automatic generation of CSP/Z files (15) which are a mathematical representation of the state model (14). The state model (14) is also used to provide for the automatic generation of RavenSPARK Ada software control codes (16). The CSP/Z tiles (15) and the software control codes (16) are used to construct a compliance argument in ProofPower® which will generate verification conditions as shown by (17). If it is verified that the CSP/Z files (15) and the software control codes (16) comply, then the verification conditions are discharged (18) providing the required certification evidence. Finally, Model Checking (not shown) will show if there are any state-related errors.

FIG. 4 shows schematically that AAA (19) may be used to generate Stateflow® input (20) for a flight control system (21), an armament control system (22) and a utility control system (23). The flight control system (21) can then be readily converted to a ClawZ file (24). The armament control system (22) and the utility control system (23) are shown as having Stateflow® outputs (25, 26 respectively).

1. A method for the generation of verified software code against a requirement, which method comprises the steps of:
i. using software to generate a state model of the requirement,
ii. using the state model to develop a software code representation of the state model and a mathematical representation of the state model,
iii. comparing the software code and mathematical representations to verify that the software code representation is a correct implementation of the mathematical representation.

2. A method according to claim 1, wherein the method comprises an additional step of performing Model Checking to demonstrate absence of state-related errors such as dead-lock and live-lock.

3. A method according to claim 1, wherein the software used to generate the state model of the requirement is Stateflow®.

4. A method according to claim 1, wherein the software code representation of the state model is produced using RavenSPARK Ada.

5. A method according to claim 1, wherein the mathematical representation of the state model is produced using ‘Circus’ or some other comparable formal language.

6. A method according to claim 1, wherein the verified software code produced is a software control code.

7. A method for the generation of verified software code, which method comprises the steps of:
i. developing a statement of requirements,
ii. using software to generate a state model from the statement of requirements,
iii. developing from the state model a formal specification in a mathematical representation,
iv. using the state model to develop software code which represents the state model,
v. constructing a compliance argument using the mathematical representation and the developed software code to provide verification conditions,
vi. generating new software code where there is disparity between the mathematical representation and the developed software code,
vii. discharging the verification conditions to prove that the new software code is a correct representation of the mathematical representation and hence the statement of requirements.

8. A method as claimed in claim 7, wherein the method comprises an additional step of performing Model Checking on the formal specification.

9. Verified software code generated in accordance with claim 1.
